(19) United States
(12) Patent Application Publication
(10) Pub. No.: US 2003/0198862 A1
(43) Pub. Date: Oct. 23, 2003

(54) Liquid gallium alkaline electrolyte fuel cell

(75) Inventor: Ralph C. Struthers, Santa Maria, CA (US)

Correspondence Address: FULWIDER PATTON LEE & UTECHT, LLP, 200 OCEANGATE, SUITE 1550, LONG BEACH, CA, 90802, US

(73) Assignee: Enernext

(21) Appl. No.: 10/126,580

(22) Filed: Apr. 19, 2002

(51) Int. Cl. H01M 8/08; H01M 8/22

(52) U.S. Cl. 429/46; 429/42; 429/13

(57) ABSTRACT

A liquid gallium-air fuel cell including an anode of liquid gallium fuel, an oxygen breathing cathode to provide hydroxyl ions into an aqueous alkaline electrolytic solution, the solution being positioned between the fuel and the cathode, and providing electrochemically reactive contact between the fuel and the hydroxyl ions of the solution to form gallium hydroxide and provide free electrons, the electrons to be harvested for the conduct of useful electrical work.

### BACKGROUND OF THE INVENTION

Fuel cells are electrochemical devices that convert the chemical energy of reaction directly into electrical energy. A fuel cell, although having similar components and several characteristics, differs from a typical battery in several respects. The battery is an energy storage device, that is, the maximum energy that is available is determined by the amount of chemical reactant stored within the battery itself. Thus, the battery will cease to produce electrical energy when the chemical reactants are consumed (i.e., discharged). The fuel cell, on the other hand, is an energy conversion device, which theoretically has the capability of producing electrical energy for as long as the fuel and oxidant are supplied to the electrodes.

Fuel cells provide a new and promising option for the efficient conversion of fossil fuels to electricity. Commercial development of fuel cell technology has been underway in the Untied States since the late 1960s with the U.S. Government playing a prominent role.

In the art of electrochemical fuel cells, electric current is produced as a byproduct of chemical reaction occurring between an anode and a cathode. Prior art cells have been proposed utilizing metallic anodes, porous cathodes through which air is fed into the cell as an oxidant, and alkaline electrolytic contact between the electrodes. For example, described in U. S. Pat. No. 4,477,539 issued to applicant, Ralph C. Struthers on Oct. 16, 1984, and entitled “METAL/GAS FUEL CELL,” is an electrochemical fuel cell that employs an anode electrode in the form of an aluminum plate, a gas cathode electrode, and two electrolytic alkaline solutions separated by a membrane. The solid aluminum anode electrode is immersed in one of the electrolytic solutions wherein hydroxyl ions are presented for reaction with the metal to form aluminum hydroxide and freeing electrons for the conduct of useful work. As a result of the reaction to form aluminum hydroxide, the solid metal anode is consumed increasing the distance between the cathode and the anode which results in current change.

### SUMMARY OF THE INVENTION

This invention is directed to a liquid gallium alkaline electrolyte fuel cell including an ion exchange chamber filled with an aqueous alkaline electrolyte solution interposed between an anode chamber filled with gallium fuel and including a current conductor in electrical contact with fuel, a gas breathing cathode to electrochemically combine electrons, oxygen gas and water from the solution to form hydroxyl ions in the solution for reaction with the gallium fuel, and a porous membrane separating the fuel and the solution and spaced from the cathode, the pores of the membrane sized to provide reactive contact between the fuel and the hydroxyl ions in the solution such reactive contact forming gallium hydroxide and producing free electrons, and an electrical conduit connected from the anode to the cathode for conduction of electrical current. Once formed in the cathode, the hydroxyl ions travel across the solution and contact the gallium fuel at the pores of the membrane to form Ga(OH)⁻₄ ions freeing up electrons for transmission through the gallium fuel and/or the anode conductor for the conduct of useful electrical work. The Ga(OH)⁻₄ ions are regenerated to form gallium hydroxide (Ga(OH)₃₎ and hydroxyl ions in the solution. The electrons return to the cell by way of an electrical conducting conduit connected from the anode to the cathode. It is to be noted that the membrane may be electrically conductive or non-conductive and may, in other embodiments, not be necessary as described below.

These and other features and advantages of the present invention will become apparent from the following detailed description which, taken in conjunction with the accompanying drawings, illustrates by way of example the principles of the invention.

### BRIEF DESCRIPTION OF THE DRAWINGS

FIG. 1 is a diagrammatic view of my fuel cell;

FIG. 2 is an isometric view of the embodiment of my fuel cell shown in FIG. 1;

FIG. 3 is an enlarged detailed transverse sectional view taken along the line 3--3 of FIG. 2;

FIG. 4 is an enlarged detailed sectional view taken substantially along the line 4--4 of FIG. 2;

FIG. 5 is the theoretical oxidation and reduction half-reaction and net reaction chemical formula for the liquid gallium alkaline electrolyte used in the fuel cell of FIG. 1; and

FIG. 6 is the theoretical standard cell potentials for half-reactions, net-reactions; Gibbs free energy and energy available from liquid gallium fuel reacted in my liquid gallium alkaline electrolyte fuel cell shown in FIG. 1;

FIG. 7 is a diagrammatic view of another embodiment of my fuel cell; and

FIG. 8 is a diagrammatic view of a further embodiment of my fuel cell.

### DETAILED DESCRIPTION OF THE PREFERRED EMBODIMENTS

My new novel liquid gallium alkaline electrolyte fuel cell includes a liquid gallium anode electrode contained in an anode chamber, an air cathode electrode and an aqueous alkaline electrolyte solution held within an ion exchange chamber interposed between the anode and the cathode. Potassium hydroxide is typically used as the alkaline electrolyte in an alkaline fuel cell and combined with water forms the aqueous solution. As will be apparent to those skilled in the art, other alkaline electrolytes such as, for example, sodium hydroxide may be employed.

The cathode is positioned adjacent the ion exchange chamber remote from the membrane and has a first surface wetted by the electrolyte solution, a second surface in contact with an oxygen gas, the oxygen gas being provided by air or other source of oxygen, and a gas and liquid permeable cathode current collector for receipt of free electrons. The cathode includes a porous substrate supporting a porous catalyst layer and is configured to electrochemically combine the free electrons received by the cathode current collector with the oxygen gas and with the water of the aqueous solution to form hydroxyl ions in the cathode and solution.

In operation of ordinary metal/air fuel cells oxygen from the air, or from an oxygen supply, is fed to the second surface of the cathode electrode to react with the electrons transmitted from the anode conductor and water of the aqueous electrolyte to form the hydroxyl ions in the cathode and solution. The hydroxyl ions migrate through the electrolyte solution to the gallium anode electrode. When the hydroxyl ions meet the liquid and/or solid gallium fuel, an electrochemical reaction takes place providing Ga(OH)⁻₄ ions and free electrons. The freed electrons are transmitted out of the fuel cell via the anode conductor creating energy. The Ga(OH)⁻₄ ions are regenerated to form gallium hydroxide (Ga(OH)₃) and hydroxyl ions in the solution.

The gallium fuel is electrochemically attacked by hydroxyl ions, forming gallium hydroxide Ga(OH)₃ and giving up electrons according to the reaction:

Anode: Ga+40H⁻→Ga(OH)⁻₄+3e⁻ E½=−1.220 V

Electrolyte Regeneration: Ga(OH)⁻₄→Ga(OH)₃+OH⁻

Net Anode: Ga+30H⁻→Ga(OH)₃+3e⁻

The freed electrons flow from the anode conductor to be tapped for useful work and flow through an electrical conduit to the collector at the cathode. At the cathode electrode, electrons received at the cathode collector are electrochemically combined with an oxidant (oxygen gas) and water and give up hydroxyl ions according to the reaction:

Cathode: ¾O₂+1½H₂O3e⁻→30H⁻ E½=⁻(+0.401) V

Net Fuel Cell Reaction Ga+¾O₂+1½H₂O→Ga(OH)₃ E°=1.621 V

The flow of hydroxyl ions through the electrolyte solution to the anode completes an electrical circuit.

The fuel cell of the present invention includes an anode electrode of liquid gallium metal to be consumed by attack of hydroxyl ions. The liquid gallium fuel in the anode chamber and the aqueous alkaline electrolyte solution in the ion exchange chamber may be replenished as required.

Gallium has become a viable commercial commodity, used in producing LEDs and GaAS laser diodes and has been recently gaining considerable interest for semiconductor purposes. Although gallium is just about as abundant as lead in the earth's crust, gallium and gallium ores are recovered as a byproduct of other refinery operations, notably those for zinc, aluminum, and iron. Ores, largely of gallium are not known. Aside from forming an 0.1% to 0.7% constituent of gerinanite, gallium occurs in nature as a regular concomitant to zinc, aluminum, indium germanium, iron, copper, manganese, tin, antimony. Almost all bauxites and zinc contain between 20 and 500 p.p.m. of gallium..

Gallium is a soft, silvery metal with a shiny surface. It is so soft that it can be cut with a knife at room temperature. When the metal is chilled, however, it becomes hard and brittle. Its melting point is just above ordinary room temperature 29.7° C. (85.5° F.) and, unlike many other elements, gallium expands upon cooling. Gallium's boiling point is about 2,400° C. (4,400° F.) and its density is 5.9037 grams per cubic centimeter. Gallium belongs to the Group-IIIA elements on the periodic table of the elements. The other elements in this group are boron (B), aluminum (Al), indium (In), an thallium (Ti). In the chemical sense, gallium is most like aluminum, but it shares a few chemical and physical characteristics with indium and thallium..

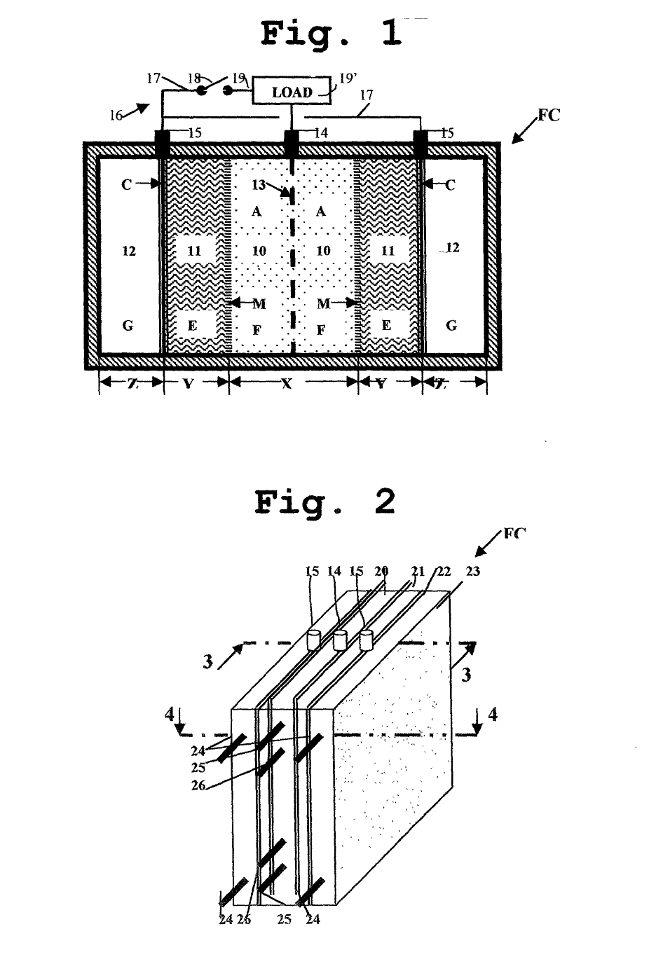

Referring to FIG. 1 is a diagram of my new fuel cell FC. The fuel cell FC is shown as an elongate sectional structure with left and right-hand ends. The exemplary cell FC includes a central anode section X sandwiched between a pair of electrolyte sections Y and a pair of outer left and right cathode sections Z disposed longitudinally outward of the electrolyte sections Y. In the embodiment depicted, the central anode section X is formed by an anode chamber 10, containing liquid gallium fuel F, having an anode conductor plate 13 in electrical contact with and immersed centrally in the fuel. The anode conductor plate terminates at its upper end in a conductor post 14.

Exposure to gallium can be corrosive to certain metals. Therefore, the selection of the anode conductor material becomes important for extended operation of the fuel cell. It is believed that, in the presence of liquid gallium, metals such as copper, iron, nickel, platinum, molybdenum, niobium, tantalum, and tungsten exhibit favorable conductive and anti-corrosive properties and are excellent candidates for use as anode conductors, including metallic membranes and anode terminal posts.

The pair of electrolyte sections Y, occurring longitudinally outward of and adjacent the opposite ends of the anode section X, are formed by ion exchange chambers 11, separated from the anode chamber 10 by respective flat porous membranes M defining respective interfaces between the fuel F and the electrolyte solutions E. The ion exchange chambers are filled with an aqueous alkaline electrolyte solution E, and a thin polypropylene flow matrix (not shown).

The pair of cathode sections Z occur longitudinally outward of the electrolyte sections Y and are separated therefrom by a pair of gas diffusion cathode electrodes C. Each cathode electrode is formed with opposing facing surfaces, a first surface to be in contact with and wetted by the electrolyte solution E, and a second surface to be in contact with an oxygen gas. The oxygen gas is contained in gas chambers 12, the oxygen gas being preferably free of carbon dioxide as carbon dioxide is believed to poison the electrolyte solution E.

The cathode electrodes are terminated out of the fuel cell in collector posts 15. The cathode sections Z further include gas chambers 12 outward of the gas diffusion cathode electrodes C and in and through which gas G is conducted to contact the second surfaces of the gas diffusion cathode electrodes C.

It is to be noted that the gas chambers 12 of the gas diffusion cathode electrode sections Z are such that any desired and suitable gas G can be used in operating my new cell. The gases G can be supplied to the gas chambers 12 from a suitable gas generating means, as circumstances require. It is to be further noted that if the gas G used at the cathode is oxygen from the ambient air, that structure which otherwise establishes the gas chambers 12 can be eliminated. In such a case, the ambient space about the cell is the full mechanical equivalent of and can be said to establish the referred to gas chambers 12.

The conductor post 14 and the collector posts 15 are accessible at the exterior of the fuel cell FC and connect by way of an electrically conducting conduit through a switch that when closed forms an electric circuit 16 that provides, during operation of the cell, a flow of freed electrons from the anode section X to the cathode sections Z. The circuit 16 is shown as including lines 17 extending from the collector posts 15 to one side of a switch 18. The other side of the switch 18 is connected with the conductor post 14 by a line 19 in which a suitable load 19′ is connected. The circuit 16 illustrated and described above is only an example of one basic form of a circuit that might be used in carrying out my invention.

It is to be noted that for effective operation and functioning of my new fuel cell, only one of the two illustrated and above noted ion exchange chambers, membranes, cathode electrodes, cathode current collectors, gas chambers, and collector posts need be provided. As described above, the provision of a single gas chamber may also be unnecessary. The provision of two sets of related electrolyte sections and cathode sections related to a single anode section is preferred since notable and apparent efficiencies are to be gained by such a combination and relationship of parts. It is further noted that any desired number of fuel cells here provided can be connected in a battery of cells to obtain desired electric output.

Referring to FIGS. 2, 3 and 4 of the drawings, I have shown certain fuel cell structural details, proposed for reductions to practice of my invention. Since the structural details are only examples of the structure that can be effectively used, I will not unduly burden this disclosure with full detailed description thereof. In the following, certain desired and necessary features of the structure illustrated will be noted.

It is to be noted that the fuel cell structure illustrated is a stacked assembly of parts held in assembled relationship by a plurality of through bolt, fastened, or bonded assemblies. A rectangular frame unit 20 with top, bottom and sidewalls defines the perimeter of the anode chamber 10 of the central anode section X. The perimeter edges of the porous membranes M overlie the opposite ends of the frame unit 20 and are held in tight, clamped and sealed engagement therewith by rectangular frame units 21 positioned longitudinally outward from the unit 20 the membranes M and which define the perimeters of the ion exchange chambers 11 of the electrolyte sections Y of the fuel cell. The perimeter of the cathodes C overlie the outwardly disposed ends of the frame units 21 and are held in tight, clamped and sealed engagement therewith by rectangular frame units 22 positioned longitudinally outward of the cathodes C. The frame units 22 have outer end walls 23 formed integrally therewith and which cooperate with the units 22 and the cathodes C to define the gas chambers 12.

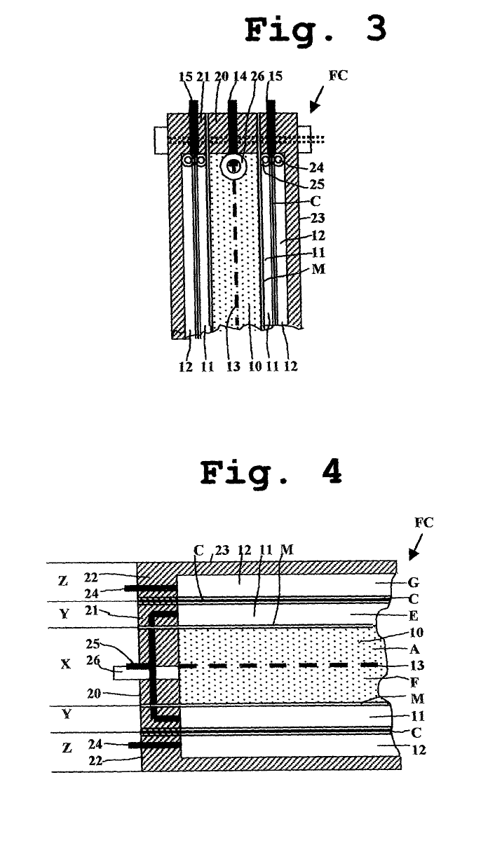

As shown in FIG. 4, the outer frame units 22 are suitably ported and provided with gas fittings 24 to conduct the gas G into and out of the gas chambers 12 of the cathode sections Z; the frame units 20 and 21 are suitably ported and are provided with suitable fluid conducting fittings 25 to conduct the aqueous electrolyte solution into the ion exchange chambers 11 and the gallium hydroxide out of the ion exchange chambers of the electrolyte sections Y; and the frame unit 20 is suitably ported and carries suitable fluid conducting fittings 26 to conduct the liquid gallium fuel F into and along with gallium hydroxide, if any, out of the anode chamber 10 of the anode section X.

In accordance with good and common practices, suitable sealing compounds and/or gaskets (not shown) are provided between the opposing abutting surfaces of the several elements and parts of the noted structure to maintain the assembled construction fluid tight.

The cathode electrodes C are thin, flat, laminated assemblies including a current collecting layer or substrate which may be laminated between layers of a nonwoven conductive fibrous web, conductive carbon fibers, impregnated with a mixture of catalyst-containing carbon particles and a nonfibrous polymeric substance, and optionally with a hydrophobic micro porous film or layer disposed on one of the layers of the nonwoven conductive fibrous web. The cathode electrodes C may be of the type commercially available from Yardney Technical Products, Inc., Pawcatuck, Conn.

The membranes M are interposed between the aqueous electrolyte solutions E and the liquid gallium fuel F to block the fuel from leaking into the ion exchange chambers 11. In essence, the membrane acts as a barrier between the gallium fuel and the electrolyte solution while providing reaction interfaces at the pores of the membrane for the hydroxyl ions (OH⁻) to react with the fuel to form Ga(OH)⁻₄ ions, gallium hydroxide (Ga(OH)₃), and provide free electrons (e⁻).

It is preferred that the membrane M be an ion-permeable material separating fuel and solution liquids contained therein. In the preferred embodiment the membrane is not wetted by the liquid gallium fuel. I prefer that the surface tension provided by the gallium fuel be sufficient to prevent the liquid gallium from leaking through the pores to the electrolyte solution. It is believed that the surface tension can be maintained by an interior surface energy of the gallium fuel that is greater than the surface energy of interaction with the membrane.

The membranes M may be selected according to pore size to afford screening. For example, a pore diameter no greater than the size of a hydroxyl ion will result in the gallium hydroxide, a larger molecule, being screened from passing through the membrane. Gallium hydroxide in such an instance would therefore be retrieved from the anode chamber 10. A pore diameter of at least the size of a gallium hydroxide molecule provides for passage of gallium hydroxide to the electrolyte solution E for subsequent collection therefrom, if desired. Additionally, the depth of the pores can be selected as desired, and may depend upon the thickness of the selected membranes and the extent, if any, of any flaring of the pore rims. The membranes may also be further selected with varying pore sizes to accommodate differential pressures that may occur within the solution and within the fuel.

The porous membranes M can be established from of any one of a number of different commercially available membrane materials. Such porous membrane materials, suitable for carrying out my invention, are attainable from many manufacturers and distributors of filter materials by specifying sheet materials of appropriate porosity, weight, thickness and strength and which are otherwise chemically inert in the environment of fuel cells of the general class here concerned with. The membrane maybe formed of a conductive metal or, for example, anon-conductive thermoplastic resin such as polypropylene, or from any other material known to those skilled in the art. When the membrane M is a conductive metallic material, it may also function as the anode conductor in electrical contact with the gallium fuel F.

In practice, the pore density of the membranes M and the concentration of hydroxyl ions (OH⁻) may be selected to control the rate at which the hydroxyl ions react with the gallium fuel F to form gallium hydroxide and free electrons. In addition to the membranes described herein, other suitable screening devices may be employed to provide electrochemically reactive contact between the hydroxyl ions and the liquid gallium fuel.

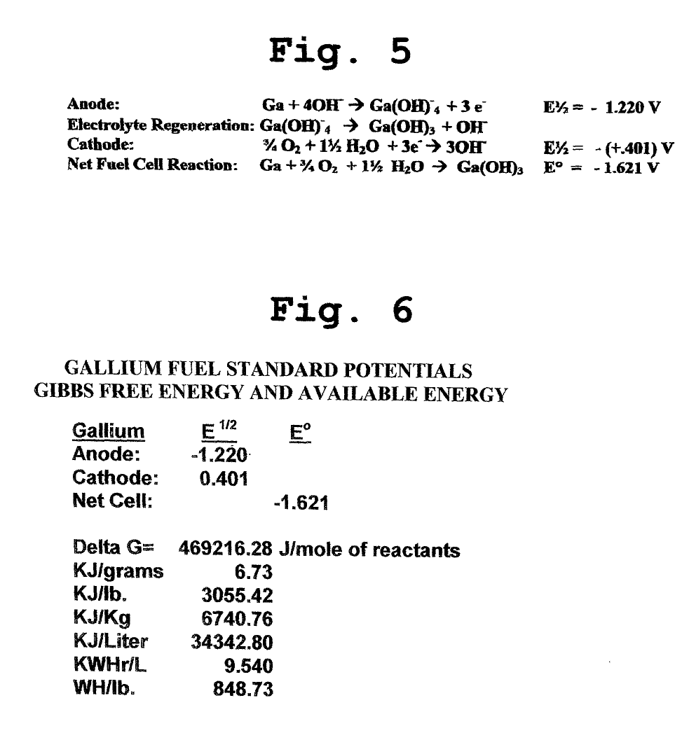

Referring to FIG. 5, the product of the liquid gallium half reaction defining the fuel side (anode or negative electrode), and that of an air breathing electrode half reaction defining the oxygen side (cathode or positive electrode) may be added together to analytically determine the net of the two reactions in my liquid gallium fuel cell.

Referring to FIG. 6, the Gibbs Free Energy referred to as “delta G” for the net reaction of the liquid gallium fuel cell 469,216.28 J/mole of reactants is shown. The energy available from one pound of liquid gallium fuel is 3055.42 kJ/pound or 6740.76 kJ/kilogram or 34,342.80 kJ/liter. In electrical terms, 9,540-watt hours/liter or 848.73 watts hours/pound. As will be appreciated by those skilled in the art any desired number of fuel cells FC may be connected in an array of fuel cells to obtain desired power output.

As an energy comparison, the theoretical energy available in a liter of gasoline is about 33,000 kJ. So a liter of liquid gallium has about 104% of the theoretical energy available in a liter of gasoline.

In furtherance of my invention, and to best describe the operation of my new fuel cell, those chemical reactions that take place in the anode section X, electrolyte sections Y, and cathode sections Z, will be given independent consideration. In this regard, cross reference can be made to FIG. 1 of the drawings for a better understanding of the invention. In accordance with the foregoing, considering the operation of the fuel cell FC embodiment of the invention in which oxygen (from the air and free of carbon dioxide) is the gas used in the cathode sections Z. In the anode section X is a liquid gallium (Ga) fuel F and the aqueous alkaline electrolyte solution E is potassium hydroxide (KOH) and water (H₂O).

Upon commencing fuel cell operation, the electrolyte solution E is ionized and presents negative hydroxyl ions (OH⁻). The negative hydroxyl ions (OH⁻) move from the electrolyte solution through the porous membranes M separating the sections X and Y. The hydroxyl ions (OH⁻) react with the liquid gallium (Ga) fuel F. The reaction between the gallium and hydroxyl ions (OH⁻) generates a byproduct of gallium hydroxide (Ga(OH)₃), plus free electrons (e⁻). The byproduct of gallium hydroxide can be precipitated or dissolved in the electrolyte solution, separated from the electrolyte solution, and may be collected for salvage purposes or to regenerate gallium fuel for reuse in a fuel cell. The free electrons (e⁻) are conducted away through the external circuit 16 to perform useful work and are thence conducted to the cathode Z to establish and maintain that chemical reaction which takes place in the cathode sections Z. So long as the external circuit 16 is closed and the electrons (e⁻) flow, the above reaction will continue. It is only necessary that the supply of electrolyte solution E and liquid gallium (Ga) be maintained and that the gallium hydroxide be continually or periodically removed, if necessary, from the electrolyte solution in section Y.

Next considering the chemical reaction in the cathode sections Z, that is, at or within the chambers 12 and cathode C, oxygen gas (O₂) from the air is supplied at the second surface of the cathode C and reacts with the electrons (e⁻) and water (H₂O) to form hydroxyl ions (OH⁻).

Next considering the chemical reaction in section Y of the cell, the electrolyte solution E is water (H₂O) and potassium hydroxide (KOH). The negative hydroxyl ions (OH⁻) move from the cathode sections Z through the electrolyte sections Y to the porous membranes M. The negative hydroxyl ions (OH⁻) from the cathode sections Z are free to combine with the gallium fuel in section X and to establish the Ga(OH)⁻₄ ions and gallium hydroxide byproduct in sections Y.

The Ga(OH)⁻₄ ions are formed by electrochemically reactive contact, at the pores of the membranes M, of the hydroxyl ions (OH⁻) in the electrolyte solution E with the gallium fuel F. The contact occurs at protruding menisci formed at the pores by either or both electrolyte solution and the gallium fuel. The contact at the menisci between the electrolyte solution and the fuel provides the interface for the electrochemical reaction of hydroxyl ions (O⁻) with the gallium fuel producing Ga(OH)⁻₄ ions and gallium hydroxide and free electrons. The menisci can be extended or reduced by adjustment of pore configuration and by provision or adjustment of pressure upon the solution and the gallium fuel.

It will be apparent that so long as the cell is operating, hydroxyl ions (OH⁻) will continue to be formed at the cathode sections Z and move through the electrolyte sections Y to the porous membranes M separating the sections X and Y; and the hydroxyl ions (OH⁻) react with the liquid gallium (Ga) fuel F to establish gallium hydroxide (Ga(OH)₃) in sections Y, in the manner set forth above. Unless and until the flow of electrons (e⁻) stop flowing from the anode section X to the cathode sections Z, the reactions in the cell sections Z, X, and Y will be in an operational mode.

Referring to FIG. 7 is shown another embodiment of my new fuel cell FC. The fuel cell is an elongate sectional structure with left and right-hand ends. The cell includes an anode A section X, an electrolyte section Y and a right-hand cathode C section Z longitudinally outward of the section Y. The anode section X includes an anode chamber 10 filled with the liquid gallium fuel F and in which a flat porous metallic membrane M additionally functions as the anode conductor 13 in electrical contact with the gallium fuel F. The electrolyte section Y, occurring longitudinally outward of and adjacent the anode section X, define an electrolyte chamber 11, separated from the anode chamber 10 by the membrane M. The electrolyte chamber 11 is filled with a thin layer of electrolyte solution E and a thin polypropylene electrolyte flow matrix to impede intermixing of the solution with the fuel. The membrane is interposed between the fuel F and the electrolyte solution E and has opposing surfaces, one opposing surface in contact with and wetted by the solution, the other opposing surface in contact with the fuel. The cathode section Z is disposed longitudinally outward of the section Y and includes an oxygen gas diffusion electrode cathode C at the outer end of the cathode section Y including a first surface in contact with and wetted by the electrolyte solution E, and a second surface in contact with the oxygen gas. The cathode C section Z further includes gas chamber 12 outward of the gas diffusion electrode cathode C and in and through which the oxygen gas G is conducted to contact the second surface of the cathode.

The fuel cell FC is suitably ported and are provided with suitable fluid conducting fittings 25 to conduct the electrolyte solution into and the electrolyte solution and gallium hydroxide out of the electrolyte chamber 11; and is suitably ported and carries suitable fluid conducting fittings 26 to conduct the liquid gallium fuel F into and out of the anode chamber 10 of the anode section X.

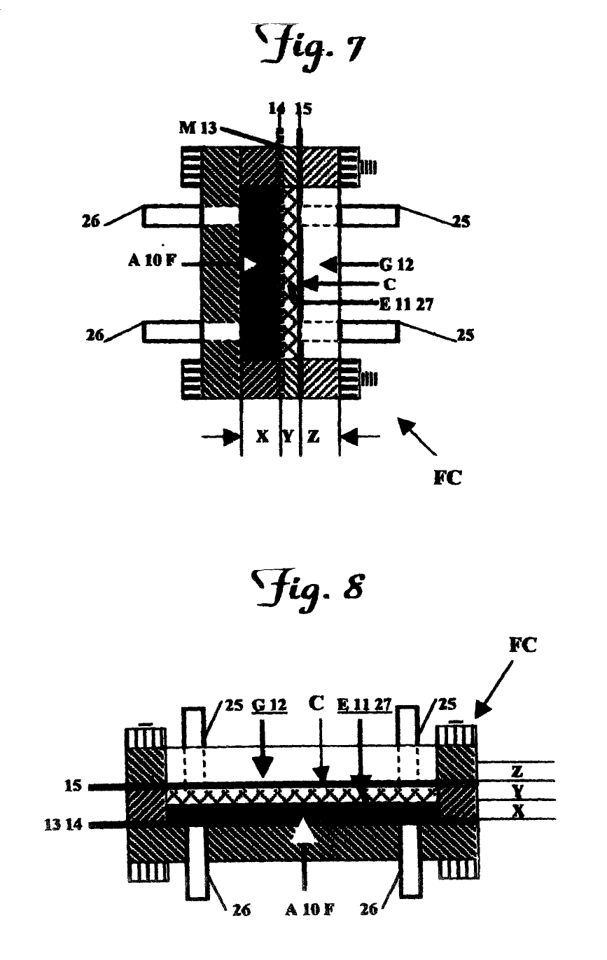

Referring to FIG. 8 is shown a further embodiment of my new fuel cell FC. In this embodiment, the fuel cell is an elongate sectional structure with top and bottom ends. The cell includes an anode section X, an electrolyte section overlaying the anode section Y, and a cathode section Z upward of the electrolyte section. The anode section X includes an anode chamber 10 filled with a liquid or solid pool of gallium fuel F on top a flat conductive metallic conductor plate 13 in electrical contact with the gallium fuel F. The electrolyte section Y, occurring upward of the anode section X, define an electrolyte chamber 11.

The electrolyte chamber 11 is filled with a thin layer of electrolyte solution E and a thin floating polypropylene electrolyte flow matrix 27. The matrix, however, is not necessary for operation of the cell and may be omitted as desired. Additionally, a membrane is not required as the relatively dense gallium fuel underlying the electrolyte solution does not pose a substantial potential of entering the electrolyte section to displace the electrolyte solution.

The cathode section Z occurs upward of the electrolyte section Y and includes an oxygen gas diffusion electrode cathode C including a first surface in contact with and wetted by the electrolyte solution E in the electrolyte chamber 11 and a second surface in contact with the oxygen gas. The cathode section Z further includes a gas chamber 12 outward of the cathode in and through which gas G is conducted to contact the second surface of the cathode.

The fuel cell FC is suitably ported and are provided with suitable fluid conducting fittings 25 to conduct the electrolyte solution into and the electrolyte solution and gallium hydroxide out of the electrolyte chamber 11; and is suitably ported and carries suitable fluid conducting fittings 26 to conduct the liquid gallium fuel F into and out of the anode chamber 10 of the anode section X.

The fuel cell FC structure is such that operation of the cell can easily and quickly be controlled by replacement of the electrolyte with a dielectric liquid with a controller for handling the electrolyte solution and the dielectric liquid and which is operable to selectively move the two liquids into and out of the fuel cell, as circumstances require. The kerosene or dielectric liquid is lighter than the electrolyte solution and as such that it will not mix with the electrolyte solution. Accordingly, the dielectric liquid normally remains in the tank atop and separate from the supply of electrolyte therein. (In practice, other dielectric liquids, such as mineral oil, might be used instead of kerosene).

The present invention may take many forms and exhibit many combinations including those manifested by the various components of my fuel cell. It is important, however, that the fuel cell include a liquid gallium anode, an oxygen breathing cathode to form hydroxyl ions, an aqueous alkaline electrolyte solution to transfer the hydroxyl ions to the gallium fuel and an interface for electrochemical reaction of the fuel with the hydroxyl ions to free electrons for the conduct of useful electrical work.

While a particular form of the invention has been illustrated and described, it will also be apparent to those skilled in the art that various modifications can be made without departing from the spirit and scope of the invention. Accordingly, it is not intended that the invention be limited except by the claims.

What is claimed is:

1. A fuel cell comprising:
an anode chamber for receipt of liquid gallium fuel and including an anode current conductor to be in electrical contact with the fuel;
an ion exchange chamber for receipt of an aqueous electrolytic alkaline solution and hydroxyl ions;
a porous membrane interposed between the anode chamber and the ion exchange chamber to separate the solution from the fuel and configured with pores sized to cause electrochemically reactive contact between the fuel and the hydroxyl ions, the contact to cause to form a reaction product of gallium hydroxide to free electrons to flow through the fuel to the anode conductor;
a cathode adjacent the ion exchange chamber spaced from the membrane and having a first surface to be wetted by the solution in the exchange chamber, a second surface to be in contact with an oxygen gas, and a gas and liquid permeable cathode current collector for receipt and transmission of the free electrons from the anode conductor, and configured to electrochemically combine the free electrons received from the anode conductor with the oxygen gas and with the water of the aqueous solution to form the hydroxyl ions in the solution; and
an electrical conduit connected between the anode conductor and the cathode collector.

2. A fuel cell comprising:
an anode chamber for receipt of liquid gallium fuel and including an anode current conductor for electrical contact with the fuel and for transmission of electrons;
an ion exchange chamber adjacent such anode chamber for receipt of an aqueous electrolyte alkaline solution and hydroxyl ions;
screening means interposed between the anode and exchange chambers to separate the solution from the fuel and operative to cause an electrochemical reaction between the fuel and the hydroxyl ions to free electrons to flow to the anode conductor;
cathode means adjacent the ion exchanger chamber, spaced from the membrane and operative to, when wetted by the solution, receive and transmit the free electrons from the anode conductor and receive an oxygen gas and to electrochemically combine the free electrons with the oxygen gas and the water of the aqueous solution to form hydroxyl ions; and
electrical conduit means connected between the anode conductor and cathode for harvesting electrical energy.

3. The fuel cell of claim 2, wherein the screening means includes a porous membrane.

4. The fuel cell of claim 2, wherein the source of the oxygen gas is air.

5. A fuel cell comprising:
an anode chamber for receipt of liquid gallium fuel and including an anode current conductor to be in electrical contact with said fuel;
an ion exchange chamber for receipt of an aqueous electrolytic alkaline solution, the solution to include hydroxyl ions;
a porous membrane interposed between the anode chamber and the ion exchange chamber to separate the solution from the fuel and configured with pores sized to cause menisci to form in the solution at the pores and to cause electrochemically reactive contact between the fuel and the hydroxyl ions at the menisci, a reaction product of gallium hydroxide to free electrons, to flow through the fuel to the anode conductor;
a cathode adjacent the ion exchange chamber spaced from the membrane and having a first surface to be wetted by the solution in the exchange chamber, a second surface to be in contact with an oxygen gas, and a gas and liquid permeable cathode current collector for receipt and transmission of the free electrons from the anode conductor, and configured to electrochemically combine the free electrons received from the anode conductor with the oxygen gas and with the water of the aqueous solution to form the hydroxyl ions in the solution; and
an electrical conduit connected between the anode conductor and the cathode collector.

6. The fuel cell of claim 5, wherein the pores are also sized to provide passage of the hydroxyl ions to the fuel.

7. The fuel cell of claim 5, wherein the pores are sized to provide passage of the gallium hydroxide to the solution.

8. The fuel cell of claim 5, wherein the cathode includes a plate formed with a layer of hydrophilic material forming the first surface of the cathode, a layer of gas permeable hydrophobic material forming the second surface of the cathode, and the cathode collector providing catalytic surfaces within the layer of hydrophilic material.

9. A fuel cell comprising:
an anode chamber for receipt of liquid gallium fuel and including an anode current conductor to be in electrical contact with said fuel;
an ion exchange chamber for receipt of an aqueous electrolytic alkaline solution, including hydroxyl ions;
a porous membrane interposed between the anode chamber and the ion exchange chamber to separate the solution from the fuel and configured with pores sized to cause menisci to form in the fuel at the pores and to cause electrochemically reactive contact between the fuel and the hydroxyl ions, the contact to cause to form a reaction product of gallium hydroxide and free electrons, said free electrons to flow through the fuel to the anode conductor;
a cathode adjacent the ion exchange chamber spaced from the membrane and having a first surface to be wetted by the solution in the exchange chamber, a second surface to be in contact with an oxygen gas, and a gas and liquid permeable cathode current collector for receipt and transmission of free electrons from the anode conductor, and configured to electrochemically combine the free electrons received from the anode conductor with the oxygen gas and with the water of the aqueous solution to form the hydroxyl ions in the solution; and
an electrical conduit connected between the anode conductor and the cathode collector.

10. The fuel cell of claim 9, wherein the pores are sized to provide passage of the hydroxyl ions to the fuel.

11. The fuel cell of claim 9, wherein the pores are sized to provide passage of the gallium hydroxide to the solution.

12. The fuel cell of claim 9, wherein the cathode includes a plate formed with a layer of hydrophilic material forming the first surface of the cathode, a layer of gas permeable hydrophobic material forming the second surface of the cathode, and the cathode collector providing catalytic surfaces within the layer of hydrophilic material.

13. A fuel cell comprising:
an anode chamber containing liquid gallium fuel and including an anode current conductor in electrical contact with said fuel;
an ion exchange chamber containing an aqueous electrolytic alkaline solution, the solution to include hydroxyl ions;
a porous membrane interposed between the anode chamber and the ion exchange chamber to separate the solution from the fuel and configured with pores sized to cause electrochemically reactive contact between the fuel and the hydroxyl ions, the contact to cause to form a reaction product of gallium hydroxide and free electrons, said free electrons to flow through the fuel to the anode conductor;
a cathode adjacent the ion exchange chamber spaced from the membrane and having a first surface to be wetted by the solution in the exchange chamber, a second surface to be in contact with an oxygen gas, and a gas and liquid permeable cathode current collector for receipt and transmission of free electrons from the anode conductor, and configured to electrochemically combine the free electrons received from the anode conductor with the oxygen gas and with the water of the aqueous solution to form the hydroxyl ions in the solution; and
an electrical conduit connected between the anode conductor and the cathode collector.

14. A fuel cell comprising:
an anode chamber containing liquid gallium fuel and including an anode current conductor in electrical contact with said fuel;
an ion exchange chamber containing an aqueous electrolytic alkaline solution, the solution to include hydroxyl ions;
a porous membrane interposed between the anode chamber and the ion exchange chamber to separate the solution from the fuel and configured with pores sized to cause menisci to form in the fuel at the pores and to cause electrochemically reactive contact between the fuel and the hydroxyl ions at the menisci, the contact to cause to form a reaction product of gallium hydroxide and free electrons, said free electrons to flow through the fuel to the anode conductor;
a cathode adjacent the ion exchange chamber spaced from the membrane and having a first surface to be wetted by the solution in the exchange chamber, a second surface to be in contact with an oxygen gas, and a gas and liquid permeable cathode current collector for receipt and transmission of free electrons from the anode conductor, and configured to electrochemically combine the free electrons received from the anode conductor with the oxygen gas and with the water of the aqueous solution to form the hydroxyl ions in the solution; and
an electrical conduit connected between the anode conductor and the cathode collector.

15. The fuel cell of claim 14, wherein the pores are sized to provide passage of the hydroxyl ions to the fuel.

16. The fuel cell of claim 14, wherein the pores are sized to provide passage of the gallium hydroxide to the solution.

17. The fuel cell of claim 14, wherein the cathode includes a plate formed with a layer of hydrophilic material forming the first surface of the cathode, a layer of gas permeable hydrophobic material forming the second surface of the cathode, and the cathode collector providing catalytic surfaces within the layer of hydrophilic material.

18. A fuel cell comprising:
an anode chamber containing liquid gallium fuel and including an anode current conductor to be in electrical contact with said fuel;
an ion exchange chamber containing an aqueous electrolytic alkaline solution, the solution to include hydroxyl ions;
a porous membrane interposed between the anode chamber and the ion exchange chamber to separate the solution from the fuel and configured with pores sized to cause menisci to form in the fuel at the pores and to cause electrochemically reactive contact between the fuel and the hydroxyl ions, the contact to cause to form a reaction product of gallium hydroxide and free electrons, said free electrons to flow through the fuel to the anode conductor;
a cathode adjacent the ion exchange chamber spaced from the membrane and having a first surface to be wetted by the solution in the exchange chamber, a second surface to be in contact with an oxygen gas, and a gas and liquid permeable cathode current collector for receipt and transmission of free electrons from the anode conductor, and configured to electrochemically combine the free electrons received from the anode conductor with the oxygen gas and with the water of the aqueous solution to form the hydroxyl ions in the solution; and
an electrical conduit connected between the anode conductor and the cathode collector.

19. The fuel cell of claim 18, wherein the pores are sized to provide passage of the hydroxyl ions to the fuel.

20. The fuel cell of claim 18, wherein the pores are sized to provide passage of the gallium hydroxide to the solution.

21. The fuel cell of claim 18, wherein the cathode includes a plate formed with a layer of hydrophilic material forming the first surface of the cathode, a layer of gas permeable hydrophobic material forming the second surface of the cathode, and the cathode collector providing catalytic surfaces within the layer of hydrophilic material.

22. A method of creating electrical energy, including:
forming an anode chamber to contain liquid gallium fuel and including an anode current conductor to be in electrical contact with said fuel for receipt and transmission of free electrons;
forming an ion exchange chamber to contain an aqueous electrolytic alkaline solution, the solution to include hydroxyl ions and to be separated from the fuel by a porous membrane;
selecting the membrane, the pores being sized to cause electrochemically reactive contact between the fuel and the hydroxyl ions, the contact to cause to form a reaction product of gallium hydroxide and free electrons, said free electrons to flow through the fuel to the anode conductor;
interposing such a membrane between the anode chamber and the ion exchange chamber to separate the fuel from the solution;
placing a cathode adjacent the ion exchange chamber remote from the membrane and having a first surface wetted by the solution, a second surface in contact with an oxygen gas, and a gas and liquid permeable cathode current collector for receipt and transmission of the free electrons, the cathode being configured to electrochemically combine the free electrons received by the cathode current collector with the oxygen gas and with the water of the aqueous solution to form the hydroxyl ions in the solution;
filling the anode chamber with the liquid gallium fuel and immersing the anode conductor in the fuel;
filling the ion exchange chamber with the aqueous electrolytic alkaline solution;
supplying the oxygen gas to the second surface of the cathode collector; and
connecting an electrical conduit from the anode conductor to the cathode collector.

23. The method of claim 22, wherein the pores are sized to form menisci in the fuel at the pores to provide the electrochemically reactive contact between the solution and the fuel.

24. The method of claim 22, wherein the pores are sized to form menisci in the solution at the pores to provide the electrochemically reactive contact between the solution and the fuel.

25. The method of claim 22, wherein the pores are sized to provide passage of the hydroxyl ions to the fuel.

26. The method of claim 22, wherein the pores are sized to provide passage of the gallium hydroxide to the solution.

27. The method of claim 22, wherein the cathode includes a plate formed with a layer of hydrophilic material forming the first surface of the cathode, a layer of gas permeable hydrophobic material forming the second surface of the cathode, and the cathode collector providing catalytic surfaces within the layer of hydrophilic material.

28. A method of making a fuel cell housing, including:
forming an anode chamber to contain liquid gallium fuel and including an anode current conductor to be in electrical contact with said fuel for receipt and transmission of free electrons;
forming an ion exchange chamber to contain an aqueous electrolytic alkaline solution, the solution to include hydroxyl ions and to be separated from the fuel by a porous membrane;
selecting the membrane, the pores being sized to cause electrochemically reactive contact between the fuel and the hydroxyl ions, the contact to cause to form a reaction product of gallium hydroxide and free electrons, said free electrons to flow through the fuel to the anode conductor;
interposing such a membrane between the anode chamber and the ion exchange chamber to separate the fuel from the solution;
placing a cathode adjacent the ion exchange chamber remote from the membrane and having a first surface wetted by the solution, a second surface in contact with an oxygen gas, and a gas and liquid permeable cathode current collector for receipt and transmission of the free electrons, the cathode being configured to electrochemically combine the free electrons received by the cathode current collector with the oxygen gas and with the water of the aqueous solution to form the hydroxyl ions in the solution; and
connecting an electrical conduit from the anode conductor to the cathode collector.

29. The method of claim 28, wherein the pores are sized to form menisci in the fuel at the pores to provide the electrochemically reactive contact between the solution and the fuel.

30. The method of claim 28, wherein the pores are sized to form menisci in the solution at the pores to provide the electrochemically reactive contact between the solution and the fuel.

31. The method of claim 28, wherein the pores are sized to provide passage of the hydroxyl ions to the fuel.

32. The method of claim 28, wherein the pores are sized to provide passage of the gallium hydroxide to the solution.

33. The method of claim 28, wherein the cathode includes a plate formed with a layer of hydrophilic material forming the first surface of the cathode, a layer of gas permeable hydrophobic material forming the second surface of the cathode, and the cathode collector providing catalytic surfaces within the layer of hydrophilic material.

34. The method of claim 33, wherein the aqueous electrolytic alkaline solution includes potassium hydroxide.

35. A fuel cell comprising:
a gallium fuel anode;
a cathode;
an electrical conduit for conducting electrons from the anode to the cathode; and
an aqueous electrolytic alkaline solution interposed between the anode and the cathode, the cathode configured to receive oxygen gas and to cause the electrons transmitted from the conduit to electrochemically combine with the water of the solution and the oxygen gas to form hydroxyl ions in the solution and to cause the hydroxyl ions to migrate across the solution to react with the fuel freeing electrons to flow through the fuel to the electrical conduit.

36. A fuel cell comprising:
a liquid gallium fuel anode;
a cathode;
an aqueous electrolytic alkaline solution interposed between the anode and the cathode, the cathode configured to receive and electrochemically combine oxygen gas and electrons with the water of the solution to form hydroxyl ions in the solution and to cause the hydroxyl ions to migrate across the solution to react with the fuel;
an electrically conductive porous membrane interposed between the solution and the anode to separate the fuel from the solution, the pores providing electrochemically reactive contact between the fuel and the hydroxyl ions to form a reaction product of gallium hydroxide and freeing electrons, the free electrons to flow through the membrane; and
an electrical conduit for conducting the freed electrons from the membrane to the cathode.
